(19) United States
(12) Patent Application Publication
(10) Pub. No.: US 2013/0082961 A1
(43) Pub. Date: Apr. 4, 2013

(54) TOUCH-SENSITIVE DEVICE AND TOUCH-SENSITIVE DISPLAY DEVICE

(71) Applicants: Wintek (China) Technology Ltd., Dongguan City (CN); Wintek Corporation, Taichung City (TW)

(72) Inventors: CHIH-YUAN WANG, Shen Kan Hsiang (TW); CHENG-YI CHOU, Tou Liao City (TW); CHIM-YAO FANG, Tai Chung City (TW); CHEN-CHU HSU, Tai Chung City (TW); YU-HUA WU, Ping Chen City (TW); XUAN-CHANG SHIU, Pi Tou Hsiang (TW); KUO-CHANG SU, Shan Hua Town (TW); CHIH-JUNG TENG, Tai Chung City (TW)

(73) Assignees: WINTEK CORPORATION, Taichung City (TW); WINTEK (CHINA) TECHNOLOGY LTD., Dongguan City (CN)

(21) Appl. No.: 13/631,251

(22) Filed: Sep. 28, 2012

(30) Foreign Application Priority Data
Sep. 30, 2011 (TW) 100135583

(51) Int. Cl. G06F 3/041

(52) U.S. Cl. 345/173

(57) ABSTRACT

A touch-sensitive device includes a transparent substrate, a decoration layer and a touch-sensing electrode layer. The decoration layer is disposed on the transparent substrate and includes a plurality of medium layers stacked with each other, and the decoration layer has at least one step portion and the step portion is defined by edges of two adjacent medium layers. The touch-sensing electrode layer is disposed on the transparent substrate and overlaps at least the step portion.

### BACKGROUND OF THE INVENTION

a. Field of the Invention

The invention relates to a touch-sensitive device and a touch-sensitive display device.

b. Description of the Related Art

FIG. 12 shows a schematic diagram of a conventional touch-sensitive device. Referring to FIG. 12, when a colored decoration layer 102 of a touch-sensitive 100 is made from a colored ink other than a black ink, the colored decoration layer 102 may provide comparatively low shading effects compared with a black ink, and thus a greater thickness is needed to compensate. Certainly, even a black ink is used to form the colored decoration layer 102, the colored decoration layer 102 may still have a greater thickness in view of specific demands. As shown in FIG. 13, in one embodiment, the colored decoration layer 102 may include five ink layers and have an overall thickness of about 30 um-40 um. In that case, subsequent fabrication processes of transparent electrodes and wiring may encounter some problems. For example, when a transparent electrode 104 extends to spread over the colored decoration layer 102, a steep drop as a result of excessively thick ink layers may break the transparent electrode 104 or cause other problem of such as poor reliability.

### BRIEF SUMMARY OF THE INVENTION

The invention provides a touch-sensitive device and a touch-sensitive display device having improved production yield and reliability.

Other objects and advantages of the invention can be better understood from the technical characteristics disclosed by the invention. In order to achieve one of the above purposes, all the purposes, or other purposes, one embodiment of the invention provides a touch-sensitive device including a transparent substrate, a decoration layer and a touch-sensing electrode layer. The decoration layer is disposed on the transparent substrate and includes a plurality of medium layers stacked with each other, and the decoration layer has at least one step portion and the step portion is defined by edges of two adjacent medium layers. The touch-sensing electrode layer is disposed on the transparent substrate and overlaps at least the step portion.

In one embodiment, the medium layers includes a bottom layer nearest the transparent substrate, a top layer farthest from the transparent substrate, and at least one middle layer between the top layer and the bottom layer.

In one embodiment, the top layer covers all the medium layers under the top layer. The top layer may be a transparent layer and may extend to cover the transparent substrate.

In one embodiment, the top layer includes a first top layer and a second top layer, the first top layer covers the middle layer and the bottom layer, the second top layer is a transparent layer and covers the first top layer, and the second top layer extends to cover the transparent substrate.

In one embodiment, the decoration layer includes a plurality of middle layers, and one of the middle layers covers all medium layers under the middle layer.

In one embodiment, the middle layer is a metallic mirror layer or a non-conductive coating layer.

In one embodiment, the middle layer is an ink layer underneath the metallic mirror layer or the non-conductive coating layer.

In one embodiment, each of the medium layers has an arc-shaped edge, and the decoration layer is disposed on a periphery of the transparent substrate.

In one embodiment, the touch-sensitive device has a touch screen area and a non-screen area, the decoration layer is disposed in the non-screen area, and at least one of the medium layers retreats from an edge of an adjacent medium layer and towards the non-screen area with a distance. The touch-sensing electrode layer is substantially disposed in the touch screen area and includes a plurality of first sensing series and a plurality of second sensing series, and at least one of part of the first sensing series and part of the second sensing series extends to the non-screen area and overlaps at least the step portion.

According to another embodiment of the invention, a touch-sensitive display device has an active display area and a non-active area and includes a touch-sensitive device and a display device. The touch-sensitive device includes a transparent substrate, a decoration layer and a touch-sensing electrode layer. The decoration layer is disposed on the transparent substrate and substantially positioned in the non-active area. The decoration layer includes a plurality of medium layers stacked with each other and at least one step portion defined by edges of two adjacent medium layers. The touch-sensing electrode layer is disposed on the transparent substrate and overlaps at least the step portion, and the display device is attached to the touch-sensitive device.

In one embodiment, the display device is attached to one side of the touch-sensitive device, and the decoration layer is disposed on the same side of the touch-sensitive device.

In one embodiment, the display device is a liquid crystal display, an organic light-emitting diode display, an electro-wetting display, a bi-stable display, or an electrophoretic display.

According to the above embodiments, since the decoration layer has multiple sub layers and shaped as a stepwise structure, the transparent electrodes or the connecting lines may, when extending to spread over the decoration layer, climb up along each gentle-sloped step portion but not suddenly raised upright to reduce the possibility of breaking and increase the wiring reliability and hence the production yield.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram of a touch-sensitive device according to an embodiment of the invention.

FIG. 2 shows a plan view of a touch-sensing electrode layer according to an embodiment of the invention.

FIG. 3 shows a schematic diagram illustrating the structure of a decoration layer according to an embodiment of the invention.

FIG. 4 shows a schematic diagram illustrating the structure of a decoration layer according to another embodiment of the invention.

FIG. 5 shows a schematic diagram illustrating the structure of a decoration layer according to another embodiment of the invention.

FIG. 6 shows a schematic diagram illustrating the structure of a decoration layer according to another embodiment of the invention.

FIG. 7 shows a schematic diagram illustrating the structure of a decoration layer according to another embodiment of the invention.

FIG. 8 shows a schematic diagram illustrating the structure of a decoration layer according to another embodiment of the invention.

FIG. 9A shows a plan view of a touch-sensing electrode layer according to another embodiment of the invention, and FIG. 9B shows a cross-section cut along line A-A′ of FIG. 9A.

FIG. 10 shows a schematic diagram of a touch-sensitive device according to another embodiment of the invention.

FIG. 11 shows a schematic diagram of a touch-sensitive display device according to an embodiment of the invention.

FIG. 12 shows a schematic diagram of a conventional touch-sensitive device, and FIG. 13 is a partial enlarged cross-section P of FIG. 12.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

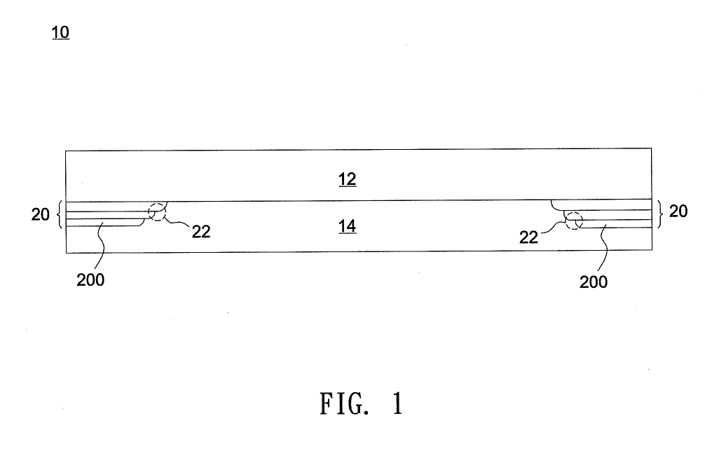

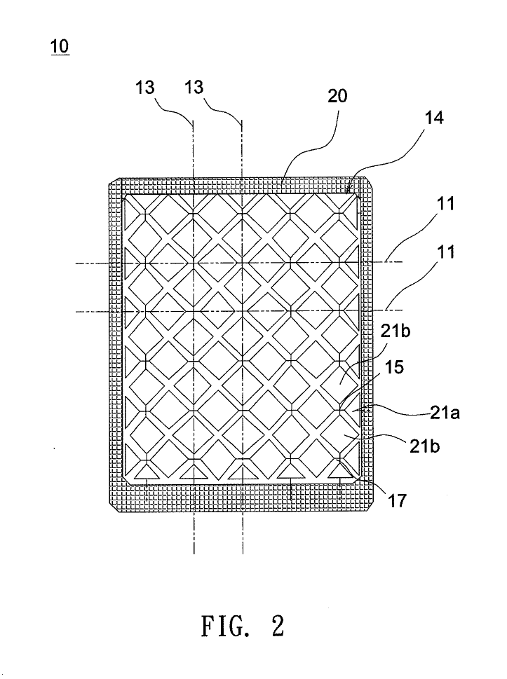

FIG. 1 shows a schematic diagram of a touch-sensitive device according to an embodiment of the invention. Referring to FIG. 1, a touch-sensitive device 10 includes a transparent substrate 12, a touch-sensing electrode layer 14, and a decoration layer 20. The touch-sensing electrode layer 14 and the decoration layer 20 are disposed on the transparent substrate 12. In this embodiment, the decoration layer 20 is disposed on a periphery of the transparent substrate 12 and includes multiple medium layers 200 stacked with each other, where a upper medium layer 200 retreats from a front edge of a lower medium layer 200 to form a step portion 22 therebetween; in other words, each step portion 22 is positioned between and defined by edges of two adjacent medium layers 200. Besides, the touch-sensing electrode layer 14 overlaps at least the step portion 22. Each of the medium layers 200 may have an arc-shaped edge to allow the decoration layer 20 to have a profile in the shape of a gentle slope. The touch-sensing electrode layer 14 may be a single-layer electrode structure or a multi-layer electrode structure. Referring to FIG. 2, the touch-sensing electrode layer 14 may include a plurality of first sensing series 11 and a plurality of second sensing series 13 spaced apart from the first sensing series 11, and part of the first sensing series 11 or part of the second sensing series 13 overlaps at least the step portion 22. Each first sensing series 11 may include multiple first transparent electrodes 21a connected with each other by multiple first connecting lines 15, and each second sensing series 13 includes multiple second transparent electrodes 21b connected with each other by multiple second connecting lines 17. The first transparent electrodes 21a and the second transparent electrodes 21b may have a regular shape such as a diamond, a triangle or a line segment or may have an irregular shape. Further, one of the first sensing series 11 and the second sensing series 13 may be disposed on the transparent substrate 12, and the other is disposed on another transparent substrate (not shown). According to the above embodiment, since the decoration layer 20 has multiple sub layers and shaped as a stepwise structure, the transparent electrodes 21a and 21b or the connecting lines 15 and 17 may, when extending to spread over the decoration layer 20, climb up along each gentle-sloped step portion but not suddenly raised upright to reduce the possibility of breaking and increase the wiring reliability and hence the production yield.

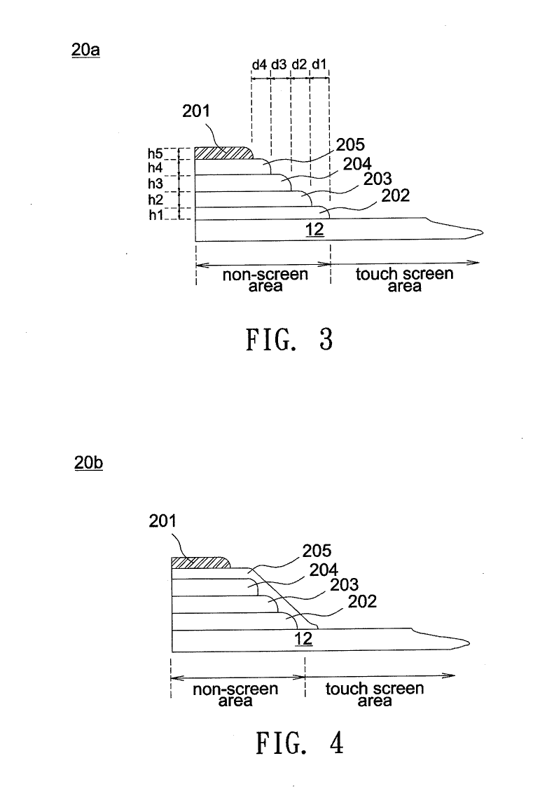

The number, material and composition of the stacked layers of the decoration layer 20 are not limited, as long as at least two medium layers 200 are provided to form a step portion 22. Herein, different structure embodiments of the decoration layer 20 are described below. As shown in FIG. 3, a decoration layer 20a may have a stack of five medium layers 200 that include a top layer 201 farthest from the transparent substrate 12, a bottom layer 202 nearest the transparent substrate 12, and middle layers 203, 204 and 205 between the top layer 201 and the bottom layer 202. In this embodiment, the middle layer 203(with a thickness h2) retreats from an edge of the bottom layer 202(with a thickness h1) and towards a non-screen area of the touch-sensitive device 10 with a distance d1, the middle layer 204 (with a thickness h3) retreats from an edge of the middle layer 203 and towards the non-screen area with a distance d2, the middle layer 205(with a thickness h4) retreats from an edge of the middle layer 204 and towards the non-screen area with a distance d3, and the top layer 201 (with a thickness h5) retreats from an edge of the middle layer 205 and towards the non-screen area with a distance d4 to form multiple step portions 22 that retreat one by one. Note, in the above embodiments, when a touch-sensitive device is combined with a display device to form a touch-sensitive display device, a touch screen area and a non-screen area of the touch-sensitive device respectively correspond to an active display area and a non-active area of the touch-sensitive display device. The top layer 201 may be formed by a color ink having comparatively low light-transmittance (such as a gray ink), and the bottom layer 202 and the middle layers 203, 204 and 205 may be formed by a color ink having comparatively high light-transmittance (such as a white ink or a colorized ink). Herein, a colorized ink is defined as a color ink except for a white ink and a black ink. Under the circumstance, better shielding effects are achieved without unduly increasing the thickness of the decoration layer 20a. Further, according to different embodiments of the invention, each of the thicknesses h1-h5 of medium layers 200 may be 1 um-15 um, and each of the retraction distance d1-d5 of medium layers 200 may be 0.05 mm-0.5 mm, preferably 0.1 mm-0.3 mm to achieve better reliability.

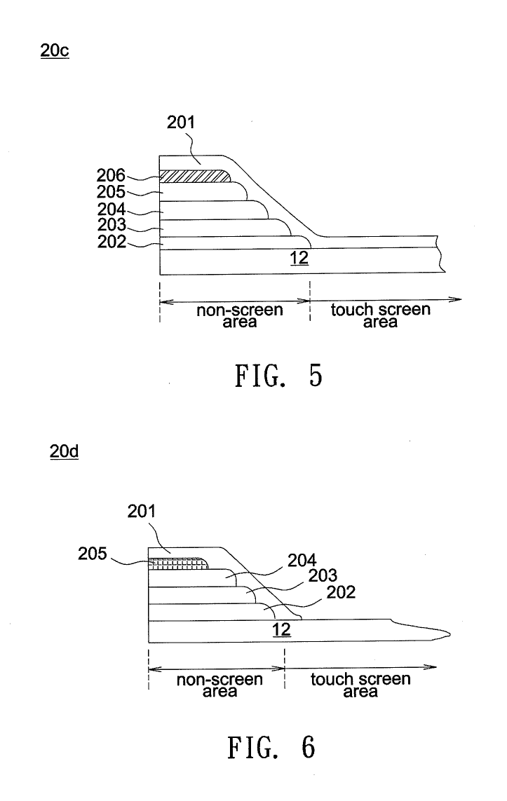

As shown in FIG. 4, in another decoration layer 20b, the top layer 201 of the decoration layer 20b is similarly formed by a color ink having comparatively low light-transmittance (such as a gray ink), and the bottom layer 202 and the middle layers 203, 204 and 205 are formed by a color ink having comparatively high light-transmittance (such as a white ink or a colorized ink). Besides, the middle layer 205 underneath the top layer 201 may extend to cover the bottom layer 202, the middle layer 203 and the middle layer 204 under the middle layer 205 to result in an even smoother gentle slope of the stepwise structure. Therefore, the electrodes or connecting lines may climb up the decoration layer 20b more easily. As shown in FIG. 5, in another decoration layer 20c, the top layer 201 may be a transparent passivation layer that extends downwardly to a touch screen area to facilitate the climb of the electrodes or connecting lines to the decoration layer 20c. In addition, the transparent passivation layer is coated on the transparent substrate 12 in the form of an entire plane to simplify fabrication processes. The top layer 201 covers the bottom layer 202, the middle layers 203, 204, 205 and 206 and the transparent substrate 12 and is in the shape of a gentle slope. In this embodiment, the top layer 201 may be formed by a transparent material such as transparent photo resist, transparent ink, silicate (like SiO₂) or overcoat to prevent ink layers under the top layer 201 from being etched and to enhance the adherence of the touch-sensing electrode layer 14 to the transparent substrate 12. Further, the middle layer 206 underneath the top layer 201 may be formed by a color ink having comparatively low light-transmittance (such as a gray ink) or an opaque black ink, and other medium layers may be formed by a color ink having comparatively high light-transmittance (such as a white ink or a colorized ink).

As shown in FIG. 6, in another decoration layer 20d, the top layer 201, the bottom layer 202 and the middle layers 203 and 204 of the decoration layer 20d may be formed by a white ink, and the middle layer 205 underneath the top layer 201 may be formed by a metallic mirror layer (such as mirror silver) or a non-conductive vacuum metallization (NCVM) layer. The metallic mirror layer has competent shading effects and relatively small thickness to reduce the entire thickness of the decoration layer 20d and facilitate the formation of electrodes and connecting wires. Besides, compared with a gray or a black ink, the metallic mirror layer does not visually affect the bottom layer 202. Further, in the decoration layer 20d shown in FIG. 6, the middle layer 204 underneath the middle layer 205 may be formed by a transparent ink to diffuse a light beam reflected by the metallic mirror layer or the NCVM layer to weaken the appearance of the metallic mirror layer or the NCVM layer.

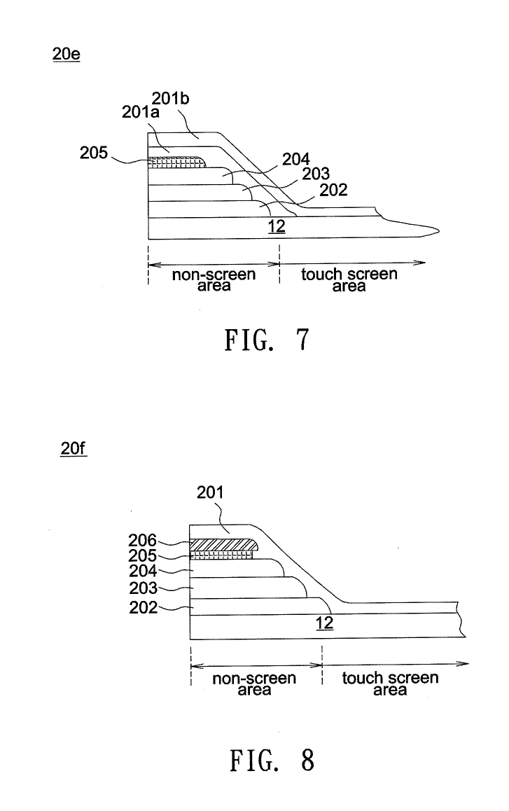

As shown in FIG. 7, in another decoration layer 20e, a first top layer 201a covers the bottom layer 202 and the middle layers 203, 204 and 205 first, so that a second top layer 201b in the shape of a gentle slope is easy to be formed as a transparent passivation layer that extends to a touch screen area and may cover all the medium layers under the transparent passivation layer and the transparent substrate 12. The first top layer 201a may be formed by a white ink or a gray ink, and the second top layer 201b may be formed by a transparent material such as transparent photo resist, transparent ink, silicate (like SiO₂) or overcoat. Further, the middle layer 205 underneath the first top layer 201a may be formed by a metallic mirror layer (such as mirror silver) or a non-conductive coating layer (such as a NCVM layer). As shown in FIG. 8, in another decoration layer 20f, the top layer 201 is a transparent passivation layer that extends to a touch screen area and covers all the medium layers under the transparent passivation layer, the middle layer 206 underneath the top layer 201 may be formed by a low light-transmittance material such as a gray ink or an opaque black ink, the middle layer 205 underneath the middle layer 206 may be formed by a metallic mirror layer (such as mirror silver) or a non-conductive coating layer (such as a NCVM layer), and the bottom layer 202 and the middle layers 203 and 204 may be formed by a white ink. The additional middle layer 206 may enhance shading effects and avoid adverse optical phenomenon occurring on the metallic mirror layer or the NCVM layer as a result of light loss of a backlight module.

According to the different embodiments of a decoration layer above, it can be clearly seen only one step portion is needed to achieve afore-mentioned effects, and the composition and material of the decoration layer are not limited and may vary according to the need of providing different shading or visual effects. For example, the medium layers may be formed by ink or photo resist with other color such as green color or yellow color, or the medium layers may be formed by other material such as ceramic or diamond-like carbon.

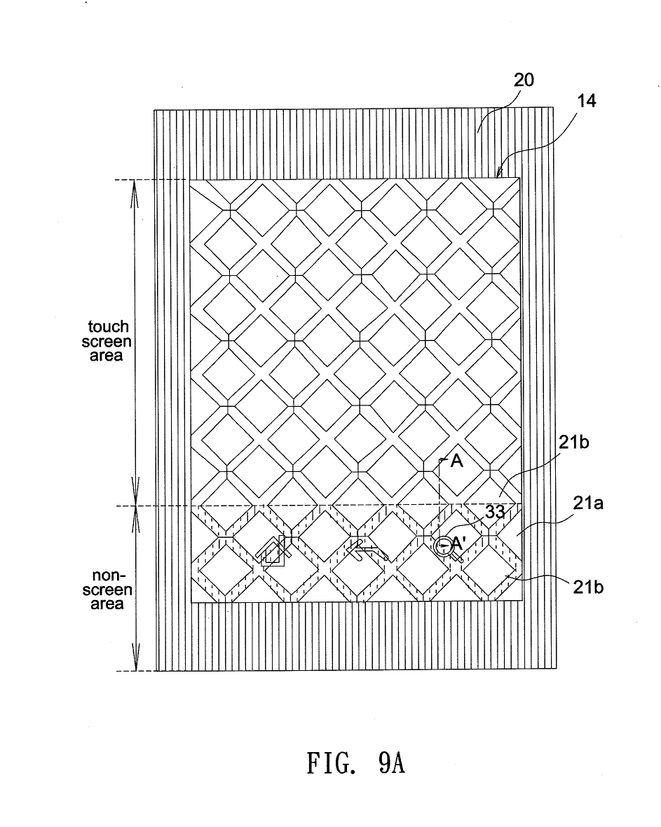

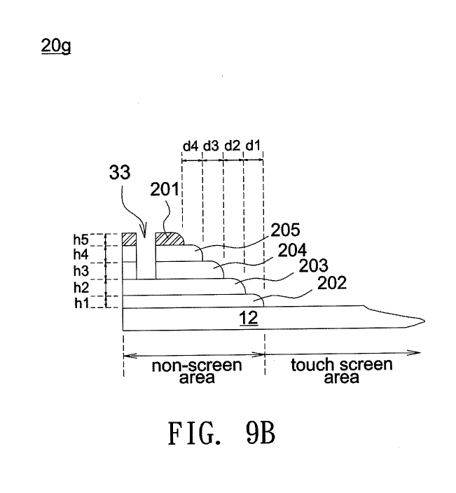

FIG. 9A shows a plan view of a touch-sensing electrode layer according to another embodiment of the invention, and FIG. 9B shows a cross-section cut along line A-A′ of FIG. 9A. Please refer to both FIG. 9A and FIG. 9B, the touch-sensing electrode layer 14 extends to spread over a part of the non screen area, and at least one pattern 33 is formed on the part of the non-screen area overlapping the touch-sensing electrode layer 14. As shown in FIG. 9B, the pattern 33 may be carved on a decoration layer 20g. In this embodiment, only the top layer 201 and the middle layers 204 and 205 are hollowed out to form the pattern 33. Therefore, since not all the medium layers 201-205 are hollowed out to form the pattern 33 (i.e., the bottom layer 202 and the middle layer 203 are not hollowed out), the pattern 33 may have restricted light-transmittance to be barely visible when a touch-sensitive device is not turned on. Certainly, in an alternate embodiment, the medium layers 201-205 may be all hollowed out to carve a clearly visible pattern 33 on a touch-sensitive device that is not turned on, and the pattern 33 may be provided with a specific color by, for example, coating a color layer on or adhering a color film to the decoration layer 20g. In addition, the pattern 33 is not limited to the type shown in FIG. 9A and FIG. 9B. In an alternate embodiment, the type of the pattern 33 may be, but is not limited to, a text (such as a letter, trademark, logo or Arabic number) or a symbol (such as an icon, graphics, geometric conformation or a hole).

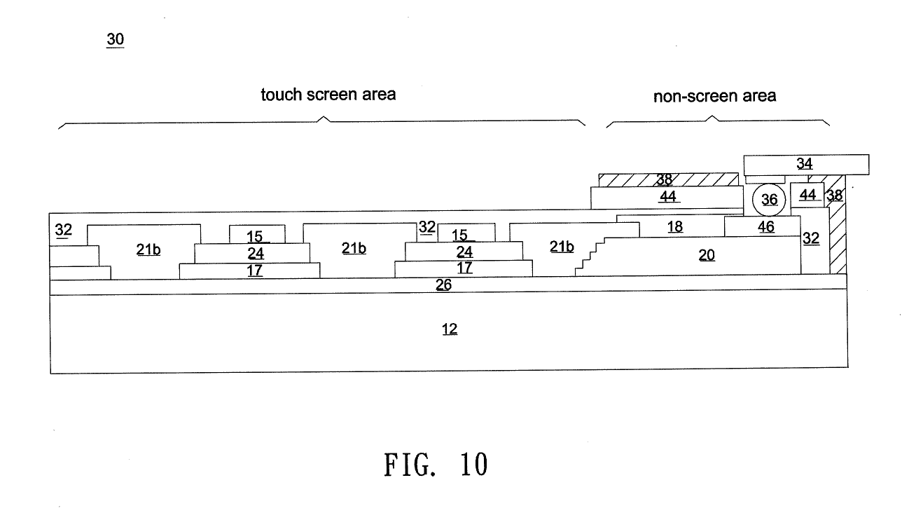

FIG. 10 shows a schematic diagram of a touch-sensitive device according to another embodiment of the invention. Referring to FIG. 10, a touch-sensitive device 30 has a touch screen area and a non-screen area, and, in this embodiment, the non-screen area is positioned in a periphery of the touch-sensitive device 30 and surrounds the touch screen area. The touch-sensing electrode layer 14 described in the above embodiments is provided in the touch screen area to detect touch actions. Among a laminate structure located in the non-screen area, a decoration layer 20 having at least one step portion is disposed on one side of the transparent substrate 12, and a trace layer 18 is disposed on the decoration layer 20 and overlaps part of the decoration layer 20. The trace layer 18 is electrically connected to the first sensing series 11 and the second sensing series 13 as shown in FIG. 2. The trace layer 18 may include multiple metal traces that extend to spread over the decoration layer 20. Besides, an insulation layer 26 may be formed on the transparent substrate 12 to cover the transparent substrate 12, and a dielectric layer 24 is interposed between first connecting lines 15 and corresponding second connecting lines 17. The transparent substrate 12 may be, for example, a glass substrate or a plastic substrate (such as a multilayered plastic substrate). In this embodiment, a passivation layer 32 may cover both the touch-sensing electrode layer 14 in the touch screen area and the laminated structure in the non-screen area to protect the entire touch-sensitive device 30. Another insulation layer 44 is formed on the passivation layer 32 and distributed only in the non-screen area, and the thickness of the insulation layer 44 is 3-100 times greater than the thickness of the passivation layer 32. A transparent conductive layer 46 is formed on the decoration layer 20 and electrically connected to the metal traces of the trace layer 18. The transparent conductive layer 46 may be formed by an ITO transparent conductive film. Each of the passivation layer 32 and the insulation layer 44 has an opening formed at a position overlapping a bonding area of the transparent conductive layer 46 to expose a part of the transparent conductive layer 46. The exposed part of the transparent conductive layer 46 is electrically connected to an external circuit through an anisotropic conductive film (ACF) 36. A sheltering layer 38 that may be made from ink is disposed on the passivation layer 32 to reduce light leakage and provide periphery protection of a wiring structure.

According to the above embodiments, since the decoration layer 20 has multiple sub layers that retreat from adjacent sub layers to formed a stepwise structure, the transparent electrodes 21a and 21b or the connecting lines 15 and 17 (at least one of part first sensing series 11 and part second sensing series 13) may climb up along each gentle-sloped step portion to extend to the non-screen area. Further, the touch-sensing electrode layer 14 is not limited to an underground-island electrode structure shown in FIG. 10. In an alternate embodiment, the connecting lines are connected with each other in an upper portion of the touch-sensing electrode layer 14 to form a bridge electrode structure. Further, the touch-sensing electrode layer 14 may be disposed on two opposite sides of the transparent substrate 12. Note the touch-sensing electrode layer 14 is not limited to be formed on the same side of the transparent substrate 12. For example, the first sensing series 11 and the second sensing serious 13 may be respectively disposed on two opposite sides of the transparent substrate 12 to form a double-sided ITO (DITO) electrode structure.

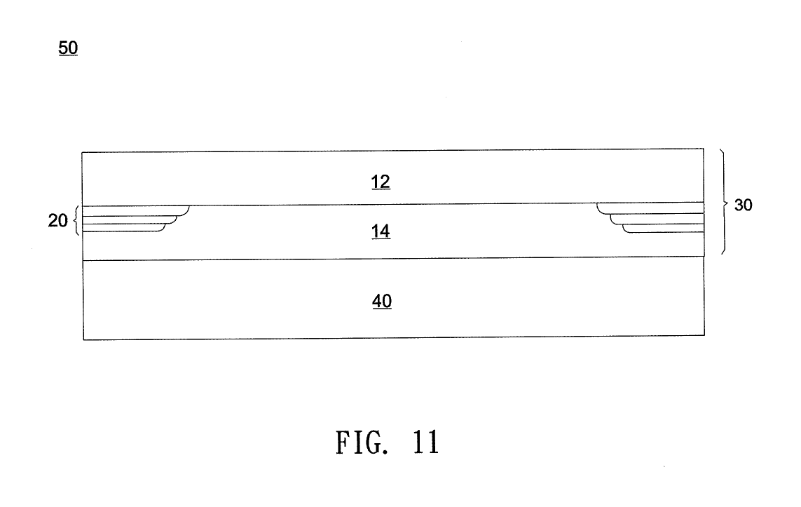

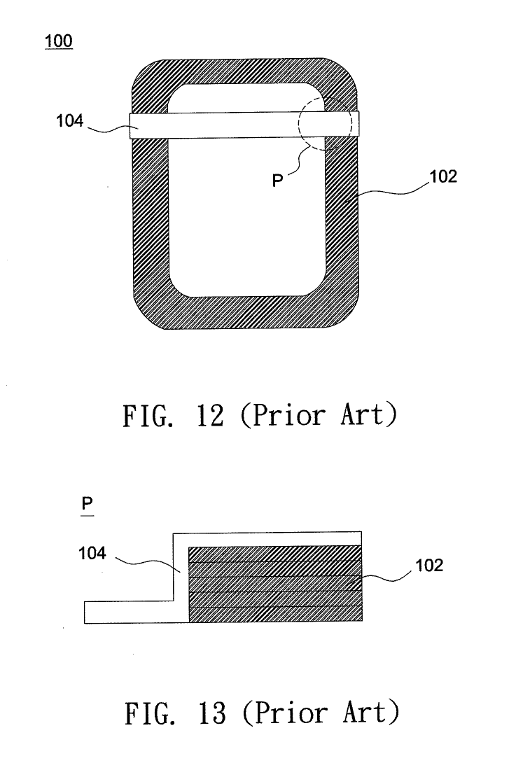

The touch-sensitive device 30 according to the above embodiments may be combined with a display device 40 to form a touch-sensitive display device 50. For example, as shown in FIG. 11, a display device 40 may be attached to one side of a touch-sensitive device 30 through an optical adhesive (not shown) to form a touch-sensitive display device 50, and the decoration layer 20 is disposed on the same side of the touch-sensitive device 30 facing the display device 40. The type of the display device 40 may be, but is not limited to, a liquid crystal display, an organic light-emitting diode display, an electro-wetting display, a bi-stable display, or an electrophoretic display.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims. Each of the terms “first” and “second” is only a nomenclature used to modify its corresponding element. These terms are not used to set up the upper limit or lower limit of the number of elements.

What is claimed is:

1. A touch-sensitive device, comprising:
a transparent substrate;
a decoration layer disposed on the transparent substrate and comprising a plurality of medium layers stacked with each other, wherein the decoration layer has at least one step portion and the step portion is defined by edges of two adjacent medium layers; and
a touch-sensing electrode layer disposed on the transparent substrate and overlapping at least the step portion.

2. The touch-sensitive device as claimed in claim 1, wherein the medium layers comprises a bottom layer nearest the transparent substrate, a top layer farthest from the transparent substrate, and at least one middle layer between the top layer and the bottom layer.

3. The touch-sensitive device as claimed in claim 2, wherein the top layer covers all the medium layers under the top layer.

4. The touch-sensitive device as claimed in claim 3, wherein the top layer is a transparent layer and extends to cover the transparent substrate.

5. The touch-sensitive device as claimed in claim 3, wherein the top layer includes a first top layer and a second top layer, the first top layer covers the middle layer and the bottom layer, the second top layer is a transparent layer and covers the first top layer, and the second top layer extends to cover the transparent substrate.

6. The touch-sensitive device as claimed in claim 2, wherein the decoration layer comprises a plurality of middle layers, and at least one of the middle layers covers all medium layers under the middle layer.

7. The touch-sensitive device as claimed in claim 2, wherein the middle layer is a metallic mirror layer or a non-conductive coating layer.

8. The touch-sensitive device as claimed in claim 7, wherein the middle layer is a transparent ink layer underneath the metallic mirror layer or the non-conductive coating layer.

9. The touch-sensitive device as claimed in claim 1, wherein each of the medium layers has an arc-shaped edge.

10. The touch-sensitive device as claimed in claim 1, wherein the transparent substrate is a glass substrate or a plastic substrate.

11. The touch-sensitive device as claimed in claim 1, wherein the decoration layer is disposed on a periphery of the transparent substrate.

12. The touch-sensitive device as claimed in claim 1, wherein the touch-sensitive device has a touch screen area and a non-screen area, the decoration layer is disposed in the non-screen area, and at least one of the medium layers retreats from an edge of an adjacent medium layer and towards the non-screen area with a distance.

13. The touch-sensitive device as claimed in claim 12, wherein the distance is 0.05 mm-0.5 mm.

14. The touch-sensitive device as claimed in claim 13, wherein the distance is 0.1 mm-0.3 mm.

15. The touch-sensitive device as claimed in claim 1, wherein the thickness of each of the medium layers is 1 um-15 um.

16. The touch-sensitive device as claimed in claim 1, wherein the touch-sensitive device has a touch screen area and a non-screen area, the decoration layer is disposed in the non-screen area, the touch-sensing electrode layer is substantially disposed in the touch screen area and comprises a plurality of first sensing series and a plurality of second sensing series, and at least one of part of the first sensing series and part of the second sensing series extends to the non-screen area and overlaps at least the step portion.

17. The touch-sensitive device as claimed in claim 1, further comprising:
at least one pattern carved on the decoration layer, wherein at least one of the medium layers is not hollowed out to form the pattern.

18. A touch-sensitive display device having an active display area and a non-active area and comprising:
a touch-sensitive device, comprising:
a transparent substrate;
a decoration layer disposed on the transparent substrate and substantially positioned in the non-active area, wherein the decoration layer comprises a plurality of medium layers stacked with each other and at least one step portion defined by edges of two adjacent medium layers; and
a touch-sensing electrode layer disposed on the transparent substrate and overlapping at least the step portion; and
a display device attached to the touch-sensitive device.

19. The touch-sensitive display device as claimed in claim 17, wherein the display device is attached to one side of the touch-sensitive device, and the decoration layer is disposed on the same side of the touch-sensitive device.

20. The touch-sensitive display device as claimed in claim 17, wherein the display device is a liquid crystal display, an organic light-emitting diode display, an electro-wetting display, a bi-stable display, or an electrophoretic display.
